(19) United States
(12) Patent Application Publication
(10) Pub. No.: US 2017/0212319 A1
(43) Pub. Date: Jul. 27, 2017

(54) Optical Device

(71) Applicant: Megaforce Company Limited, New Taipei City (TW)

(72) Inventor: Yen-Fang Cheng, New Taipei Citt (TW)

(21) Appl. No.: 15/262,098

(22) Filed: Sep. 12, 2016

(30) Foreign Application Priority Data
Jan. 26, 2016 (TW) 105102297
Jan. 26, 2016 (TW) 105201125

(51) Int. Cl. G02B 6/42

(52) U.S. Cl. CPC G02B 6/4237; G02B 6/4204; G02B 6/4244

(57) ABSTRACT

An optical device includes a first optical component having a first optical axis and a second optical component having a second optical axis. The first optical component is mounted on the second optical component. No adhesive is between the first optical component and the second optical component. The first optical component has two opposite side surfaces which cover the second optical component and each have a row of laser welding spots formed thereon. A collimation error between the first optical axis and the second optical axis is not greater than 0.5 micrometer.

### BACKGROUND OF THE INVENTION

1. Field of the Invention

The present invention relates to an optical device and, more particularly, to an optical device employing laser welding to connect or fix optical components.

2. Description of the Prior Art

An assembly of optical components in an optical device usually has a strict demand of positioning. A conventional, commonly used method is to employ ultraviolet (UV) light curing adhesives to connect or fix optical components. However, the method has some shortcomings. For example, adhesives have to be cured by exposure to UV light and to be manually dispensed to produce higher yield, resulting in requiring more time and effort. Another method is to employ laser welding to connect or fix optical components. The method may save time, easily realize automation, and have higher connection strength. However, laser welding causes stresses within the optical components, resulting in position deviation of the optical components after welding. Later, a method is developed which employs adhesives and then laser welding to connect or fix optical components, for example the disclosure of Taiwan patent number 1386268. The method may reduce position deviation caused by laser welding, but it requires much more time and material.

### SUMMARY OF THE INVENTION

The present invention is adapted to providing an optical device which only employs laser welding to connect or fix optical components and may improve position deviation of the optical components after welding.

According to an aspect of the present invention, there is provided an optical device including a first optical component and a second optical component. The first optical component has a first optical axis, and the second optical component has a second optical axis. The first optical component is mounted on the second optical component. No adhesive is between the first optical component and the second optical component. The first optical component has two opposite side surfaces which cover the second optical component and each have a row of laser welding spots formed thereon. A collimation error between the first optical axis and the second optical axis is not greater than 0.5 micrometer (um).

According to another aspect of the present invention, there is provided an optical device including an optical unit and a support component. The optical unit includes two optical axes, and a collimation error between the two optical axes is not greater than 0.5 um. The support component has a first surface and a second surface opposite to the first surface. The optical unit is disposed on the first surface of the support component. The second surface of the support component has a row of laser welding spots formed thereon corresponding to the optical unit.

These and other objectives of the present invention will no doubt become obvious to those of ordinary skill in the art after reading the following detailed description of the preferred embodiment that is illustrated in the various drawings.

### BRIEF DESCRIPTION OF THE DRAWINGS

FIG. 1 is an exploded view of an optical device according to an embodiment of the present invention;

FIG. 2 is a perspective view of an optical device according to an embodiment of the present invention;

FIG. 3 is a cross-sectional view of an optical device according to an embodiment of the present invention; and

FIG. 4 is a perspective view of an optical device according to another embodiment of the present invention.

### DESCRIPTION OF THE PREFERRED EMBODIMENTS

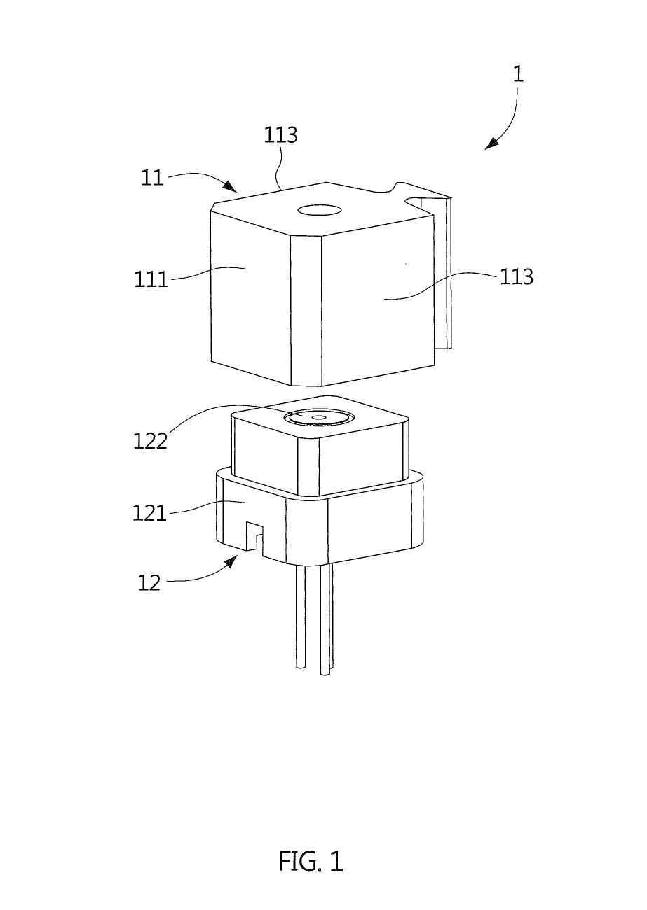

Referring to FIG. 1 to FIG. 3, there are shown an exploded view, a perspective view, and a cross-sectional view of an optical device 1 according to an embodiment of the present invention respectively. The optical device 1 includes a first optical component 11 and a second optical component 12. The first optical component 11 has a first optical axis, and the second optical component 12 has a second optical axis. The optical component may be a light-emitting or lens component having an optical axis. In the embodiment, the first optical component 11 is a lens component including a lens holder 111 and a lens 112 disposed in the lens holder 111. The first optical axis of the first optical component 11 is the optical axis of the lens 112. The second optical component 12 is a laser component including a diode holder 121 and a laser diode 122 disposed on the diode holder 121. The second optical axis of the second optical component 12 is the optical axis of the laser diode 122.

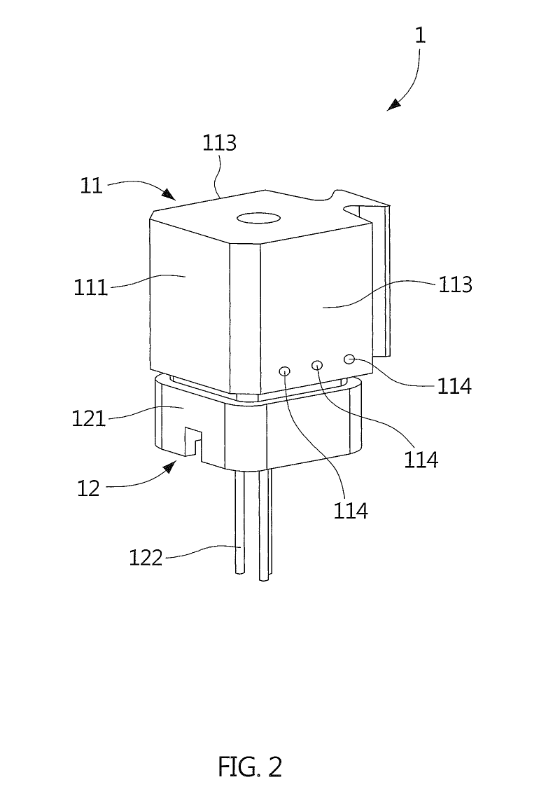

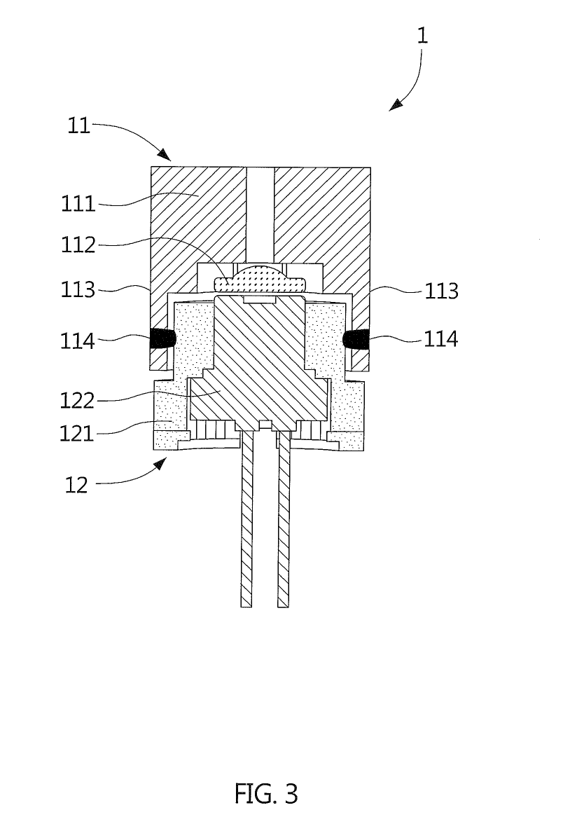

As shown in FIG. 2 and FIG. 3, the first optical component 11 is mounted on the second optical component 12. The first optical component 11 has two opposite side surfaces 113 which cover the second optical component 12 and each have a row of laser welding spots 114 formed thereon. These laser welding spots 114 may be black circular spots. A collimation error between the first optical axis of the first optical component 11 and the second optical axis of the second optical component 12 is not greater than 0.5 um so as to satisfy demand of positioning of the optical components. As shown in FIG. 3, the first optical component 11 and the second optical component 12 are melted at these laser welding spots 114 to join or fix together. In addition, no adhesive is between the first optical component 11 and the second optical component 12.

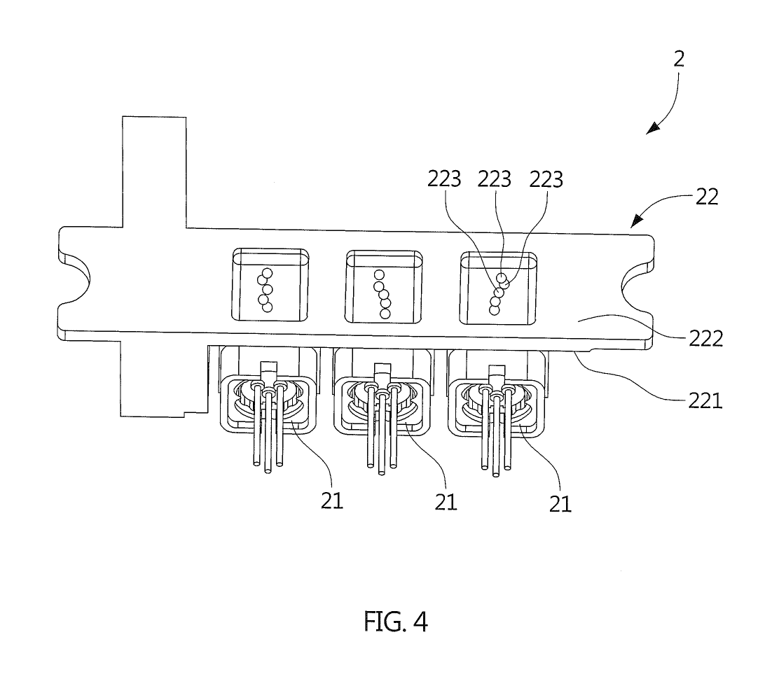

Referring to FIG. 4, there is shown a perspective view of an optical device 2 according to another embodiment of the present invention. The optical device 2 includes three optical units 21 and a support component 22. Each optical device 21 includes two optical axes between which a collimation error is not greater than 0.5 um. In the embodiment, the three optical units 21 each employ the optical device 1 as shown in FIG. 2, and are used to emit red, green, and blue lights respectively. The two optical axes of each optical device 21 are the first optical axis of the first optical component 11 and the second optical axis of the second optical component 12 respectively.

The support component 22 has two opposite surfaces, that is, a first surface 221 and a second surface 222 opposite to the first surface 221. The optical unit 21 is disposed on the first surface 221 of the support component 22. The second surface 222 of the support component 22 has a row of laser welding spots 223 formed thereon corresponding to each optical unit 21. In the embodiment, there are three rows of laser welding spots 223 due to the three optical units 21. Each row of laser welding spots 223 may be in a line or in a ragged line. The optical units 21 and the support component 22 are melted at these laser welding spots 223 to join or fix together. In addition, no adhesive is between each optical unit 21 and the support component 22.

In sum, by forming a row of laser welding spots 114 on each of the two opposite side surfaces 113 of the first optical component 11 covering the second optical component 12, or by forming a row of laser welding spots 223 on the second surface 222 of the support component 22 corresponding to each optical unit 21, the present invention may satisfy demand of positioning of the optical components or the optical units.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

1. An optical device comprising:
a first optical component having a first optical axis; and
a second optical component having a second optical axis,
wherein:
the first optical component is mounted on the second optical component;
no adhesive is between the first optical component and the second optical component;
the second optical component has an annular peripheral surface;
the first optical component has two opposite side surfaces which cover the annular peripheral surface of the second optical component;
each opposite side surface has a row of laser welding spots formed thereon, with the laser welding spots being spaced from each other and melting the annular peripheral surface and the side surface to join the first and second optical components together; and
a collimation error between the first optical axis and the second optical axis is not greater than 0.5 micrometer.

2. The optical device of claim 1, wherein the first optical component comprises a lens component defining the first optical axis, and the second optical component comprises a laser component defining the second optical axis.

3. An optical device comprising:
an optical unit comprising two optical axes, with a collimation error between the two optical axes being not greater than 0.5 micrometer; and
a support component having a first surface and a second surface opposite to the first surface,
wherein the optical unit is disposed on the first surface of the support component; and
the second surface of the support component has a row of laser welding spots formed thereon corresponding to the optical unit, with the laser welding spots being spaced from each other and melting the support component and the optical unit to join the support component and the optical unit together.

4. The optical device of claim 3, wherein:
the optical unit comprises a first optical component and a second optical component having the two optical axes respectively;
the first optical component is mounted on the second optical component;
no adhesive is between the first optical component and the second optical component; and
the second optical component has an annular peripheral surface;
the first optical component has two opposite side surfaces which cover the annular peripheral surface of the second optical component;
each opposite side surface has another row of laser welding spots formed thereon, with the laser welding spots of the other row being spaced from each other and melting the annular peripheral surface and the side surface to join the first and second optical components together.

5. The optical device of claim 4, wherein the first optical component comprises a lens component defining one of the two optical axes, and the second optical component comprises a laser component defining another of the two optical axes.

6. An optical device comprising:
a lens component comprising a lens holder and a lens disposed in the lens holder, with the lens component having a first optical axis which is an optical axis of the lens; and
a laser component comprising a diode holder and a laser diode disposed on the diode holder, with the laser component having a second optical axis which is an optical axis of the laser diode,
wherein:
the lens component is mounted on the laser component;
no adhesive is between the lens component and the laser component;
two opposite sidewalls of the lens holder cover and are close to two opposite sidewalls of the diode holder, respectively;
a row of laser welding spots is formed on an outer surface of each of the two opposite sidewalls of the lens holder, with the laser welding spots being spaced from each other in the row;
the two opposite sidewalls of the lens holder and the diode holder are melted at the row of laser welding spots to join the lens component and the laser component together; and
a collimation error between the first optical axis and the second optical axis is not greater than 0.5 micrometer.
